(19) United States
(12) Patent Application Publication
(10) Pub. No.: US 2003/0229871 A1
(43) Pub. Date: Dec. 11, 2003

(54) Method of generating timing constraint model of logic circuit, program for generating timing constraint model of logic circuit, and timing-driven layout method of using the timing constraint model

(75) Inventors: Tatsuya Nakae, Kawasaki (JP); Tadashi Konno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED of Kawasaki, Japan

(21) Appl. No.: 10/453,621

(22) Filed: Jun. 4, 2003

(30) Foreign Application Priority Data
Jun. 10, 2002 (JP) 2002-169014

(51) Int. Cl. G06F 9/45; G06F 17/50

(52) U.S. Cl. 716/6

(57) ABSTRACT

An STA script input section receives input of an STA script that includes a clock information and a path disconnection information. A path permissible delay time calculator extracts paths that do not have the disconnection information, and calculates a permissible delay time from a starting point to an ending point of each of the paths. A CCS preparing section prepares the timing constraint model of the compatible constraint set that describes the timing constraints of each path, and the disconnection information, for a plurality of groups of information to have no contradiction between the paths extracted and the disconnection information. Finally, a CCS combining unit obtains one compatible constraint set that takes into account operation modes by simply combining the compatible constraint sets output from the CCS preparing section.

### CROSS-REFERENCE TO RELATED APPLICATIONS

This application is based upon and claims the benefit of priority from the prior Japanese Patent Application No., filed on, the entire contents of which are incorporated herein by reference.

### BACKGROUND OF THE INVENTION

1) Field of the Invention

The present invention relates to generation of timing constraints of a logic circuit.

2) Description of the Related Art

Generally, a logic circuit available in recent years has a plurality (for example, N, where N is a natural number) of operation modes such as functions and a processing speed. The operation mode includes, for example, a system mode, a test operation mode, a standby mode, a low power consumption mode, mode of digital televisions corresponding to each country, and universal serial bus (USB) high-speed and low-speed operation modes. The logic circuit must satisfy all the timing constraints (i.e., N constraints) required for the N operation modes of the logic circuit. As elements that constitute the logic circuit, there are cells of flip-flops (FF), input/output (I/O) terminals, and memory elements like ROMs (Read Only Memory) and RAMs (Random Access Memory).

In general, the circuits that execute various operation modes are not completely isolated, but are rather made common to minimize the scale of the circuit (i.e., to reduce cost). FIG. 1 shows an example of a structure of a conventional logic circuit that has plural operation modes. In FIG. 1, the operation modes of the cells of flip-flops FF1 to FF8 that constitute the logic circuit are controlled based on a control signal SEL supplied from the inside or the outside. Frequencies of clocks CK1 and CK2 supplied to the FF1 to FF8 of the logic circuit, the operation (i.e., functions) of the logic circuit, and data paths, are changed over respectively, based on the control signal SEL. For example, in the structure shown in FIG. 1, it is possible to change over the clocks CK1 and CK2 supplied to the cells FF3 and the FF4, based on the control signal SEL to a selector 70. When the supplied contents of the control signal SEL are different, that is, when the control signal SEL is changed over between “1” and “0”, the timing constraints of the data paths from the cells FF3 and the FF4 are different.

A timing model and optimization method of logic circuits have been conventionally provided based on a logic synthesis or a timing-driven layout system (TDL) conventionally. FIG. 2 is a flowchart that shows the processing according to the conventional timing optimizing system. At a timing analysis step (step S81), a static timing analyzer (hereinafter, “STA”) inputs a script (hereinafter, “STA script”), and the system verifies whether the circuit satisfies timing constraints (i.e., specifications) described in the script. The STA script describes a clock timing and a disconnection point of a circuit that the user wants to describe according to its timing specifications, according to a predetermined format. This is a conventional technique.

Thereafter, the system decides whether the logic circuit satisfies all the N timing constraints (step S82). If there is a timing constraint that is not satisfied (No at step S82), the system optimizes the circuit under the constraint by using the TDL (step S83). In this case, the system takes out one timing constraint not satisfied (unsatisfactory) (step S83a), and optimizes the circuit under this timing constraint by using the timing-driven layout system (step S83b). The system decides whether there is other timing constraint that is not satisfied (step S83c). If there is such a timing constraint, the system repeats the same processing starting from step S83a and optimizes the circuit. The process returns to step S81, and when the circuit satisfies all the timing constraints from 1 to N described in the STA script (Yes at step S82), the system ends the optimization processing. The steps S83a, S83b, and S83c will be collectively referred to as step S83.

According to the timing model and optimization method of using the timing-driven layout system (TDL) at step S83, the system can take into account only one operation mode (i.e., timing constraint) at one time. For example, at the time of optimizing under the timing constraint of the operation mode 1, the system does not take into account the timing constraints of the operation modes 2 to N. When the system optimizes the timing of the circuit under the timing constraint of the operation mode 2 after optimizing under the timing constraint of the operation mode 1, the system might destroy the optimization result under timing constraint of the operation mode 1.

As explained above, when operation modes (i.e., timing constraints) exist, the timing optimization processing carried out by the conventional timing optimizing system is an incessant temporary sub-optimization. In other words, after one operation mode is satisfied, other optimization state changes. As a result, the turnaround time (TAT) until the circuit satisfies all the operation modes becomes very long. Depending on the situation, it is not possible to obtain an optimized circuit.

Therefore, when the timing optimizing system is used, the following methods are employed.

Method (1): The system first optimizes the timing of the circuit under the timing constraint of the operation mode considered the most important, or the severest timing constraint. Thereafter, while paying attention not to destroy the once-optimized timing characteristic of the circuit, the operator manually changes the circuit or refines other timing constraints to optimize the timing of the circuit under them.

Method (2): The system first generates a timing constraint by combining timing constraints of all operation modes, thereby to optimize the circuit. The timing constraint becomes severer or milder than the actual constraint. Thereafter, by paying attention not to destroy the once-optimized timing characteristic of the circuit, the operator manually changes the circuit or refines other timing constraints to optimize the timing of the circuit under them.

However, according to these methods (1) and (2), it is not possible to obtain the optimized solution, because it is not possible to simultaneously optimize the timing of the circuit under the timing constraints of all the operation modes. As it is possible to optimize only one operation mode at one time, the turnaround time increases frequently, with reduced efficiency.

According to the method (2), when the timing constraints are combined together, a part of the circuit is optimized under a severer condition than the actual timing constraint. This brings about an extremely distorted layout, such as the increase in power consumption due to the increase in the circuit scale, the increase in required chip area, and the failure in routing because of poor routability. As a result, the layout processing does not converge. It is very difficult to artificially prepare timing constraints that avoid the occurrence of these problems. Further, it is difficult to artificially extract and combine only suitable timing constraints.

### SUMMARY OF THE INVENTION

It is an object of this invention to at least solve the problems in the conventional art.

According to one aspect of the present invention, a static timing analyzer script including a clock information, which is supplied to the logic circuit, and a disconnection information, which indicates which path is to be disconnected among a plurality of paths between the cells, is input. Based on this STA script, paths excluding the path having the disconnection information are extracted, and a permissible delay time on the path between a cell starting point and a cell ending point is calculated. A timing constraint model called a compatible constraint set (CCS) is generated for each group, each describing time constraints on paths and the disconnection information without generating contradiction between existence of time constraint on paths and the disconnection information. The STA script includes a multi-cycle path assignment to make an exceptional path assignment by multiplying the path constraint by k times. It is also possible to take this assignment to generate CCS.

According to the above aspect, it is possible to generate a plurality of timing constraint models (i.e., the CCSs) that describe the time constraints of each path and the disconnection information in the STA script for different operation modes, without generating a contradiction between the paths and the disconnection information. It is possible to obtain one CCS by simply combining the descriptions of the CCSs. It is also possible to generate a CCS by selecting a permissible delay time suitable for a predetermined constraint such as a setup condition. The timing-driven layout system using this timing constraint model can simultaneously optimize the timing of the circuit under the timing constraints of operation modes.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 shows one example of a structure of a conventional logic circuit that has plural operation modes;

FIG. 2 is a flowchart that shows the processing according to the conventional timing optimizing system;

FIG. 3 is a flowchart that shows the contents of processing by a method of generating timing constraints of a logic circuit according to the present invention;

FIG. 4 shows an example of a structure of a logic circuit at the time of preparing CCSs of one operation mode;

FIG. 5 shows the contents of an STA script that is necessary to prepare the CCSs;

FIG. 6 shows the contents of the CCSs prepared based on the STA scripts;

FIG. 7 is a block diagram that shows functions of the CCS preparing system for one operation mode;

FIGS. 8A and 8B explain a procedure of preparing CCSs for the operation modes,

FIG. 9 shows a CCS that expresses different operation modes at the same time;

FIG. 10 is a block diagram that shows functions of the CCS preparing system for operation modes;

FIG. 11 shows a procedure of preparing a CCS by combining path permissible delay times;

FIG. 12 shows a CCS prepared based on optimized information;

FIG. 13 is a block diagram that shows functions of the CCS preparing system for operation modes;

FIG. 14 is a block diagram that shows functions of the CCS preparing system that carries out a path constraint change processing;

FIG. 15 shows a procedure of preparing a CCS changed path constraints (part 1);

FIG. 16 shows the procedure of preparing the CCS changed path constraints (part 2);

FIG. 17 is a block diagram that shows functions of the CCS preparing system that restructures and re-optimizes an existing CCS;

FIG. 18 shows a procedure of preparing a CCS based on an existing CCS and an additional STA script;

FIG. 19 shows a CCS obtained by simply combining an additional STA script;

FIG. 20 shows a procedure in which the CCS preparing system prepares a differential script based on STA scripts of different operation modes;

FIG. 21 is a block diagram that shows functions of the CCS preparing system that generates a differential STA script;

FIG. 22 is a block diagram that shows a total structure of the CCS preparing system;

FIG. 23 is a block diagram that shows the timing-driven layout system using a CCS;

FIGS. 24A to 24C explain the assignment of CCSs to be processed by the TDL; and

FIGS. 25A and 25B show one example of a CCS and a result of a slack analysis.

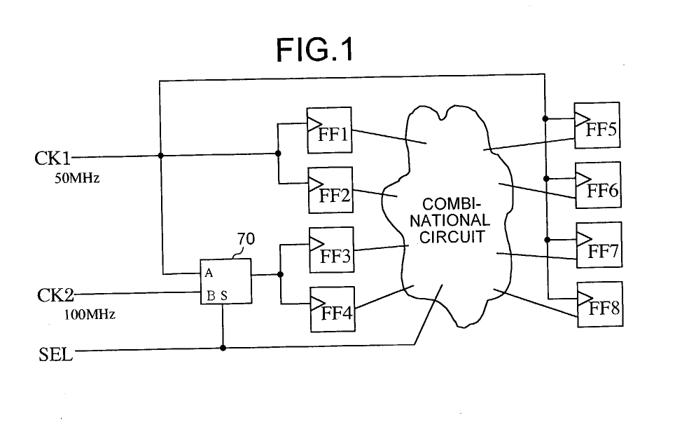

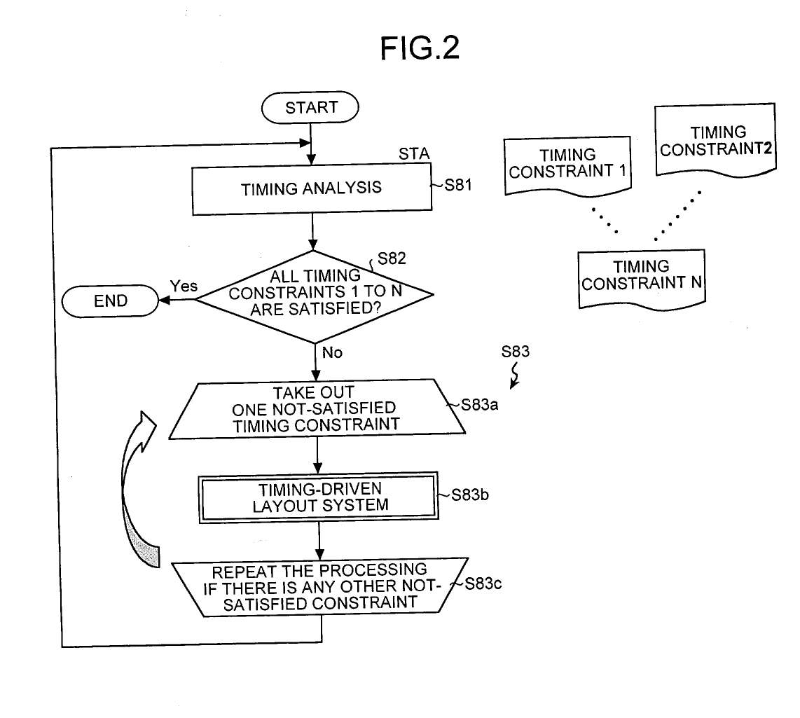

### DETAILED DESCRIPTION

Exemplary embodiments of the apparatus that generates timing constraints of a logic circuit and the method therefor according to the present invention are explained with reference to the accompanying drawings. The timing constraint method or the timing constraint model used in the apparatus according to the present invention is called the compatible constraint set (CCS). The basic concept of the CCS is announced in the thesis of “A method of generating timing constraints by taking into account a plurality of clocks”, Taeko MATSUNAGA, et al., Design Gaia, Nov. 27, 1999. The present applicant applied “A method of generating timing constraints of a logic circuit, and a computer-readable recording medium that stores a program therefor” in Japanese Patent Application No. 12-349915.

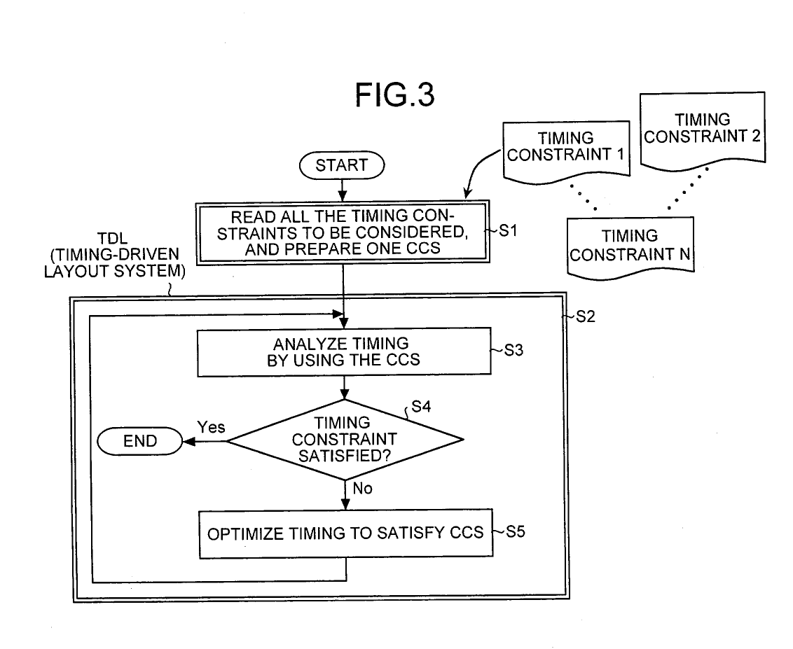

FIG. 3 is a flowchart that shows the contents of processing by the method for generating timing constraints of a logic circuit according to the present invention. When there are a plurality of timing constraints 1 to N, this system can take into account operation modes. First, the system reads all the timing constraints to be considered, and prepares one CCS (step S1). The CCS prepared is called a timing constraint model CCS. Next, the TDL optimizes all the timing constraints shown in the CCS (step S2).

At step S1, the system inputs the timing constraints of operation modes that need to be simultaneously considered, and prepares the timing constraint CCS that can simultaneously consider the operation modes. At step S2, the TDL analyzes the timing by using the CCS (at step S3). Until the timing constraint is satisfied (No at step S4), the TDL continues the timing optimization to satisfy the CCS (step S5). When the timing is satisfied (Yes at step S4), the system end the optimization.

As the CCS expresses the timing constraints of all the operation modes that should be taken into account, it is possible to optimize the timing of the circuit for all the operation modes at one time by optimizing under the timing constraints expressed in the CCS. It is possible to obtain the timing constraints expressed in the CCS, by simply combining the timing constraints that are necessary for the individual operation modes. Therefore, it is possible to satisfy the timing constraints that are necessary for the individual operation modes. Consequently, it is possible to obtain a result (layout) that follows the actual timing constraints.

The system that prepares the CCS has a unit that can add and delete specific path time constraints (a group of information), which corresponds to the preparation of the CCS based on the STA script as described later. This system can effectively express only necessary information following the necessary conditions.

The above system can solve the conventional problems of the incessant temporary sub-optimization of the timing, the distorted layout, and the re-preparation of the timing constraints to optimize the timing. As a result, it is possible to reduce the turnaround time of designing the circuit that has operation modes, and optimize the layout.

Preparation of the CCSs of One Operation Mode

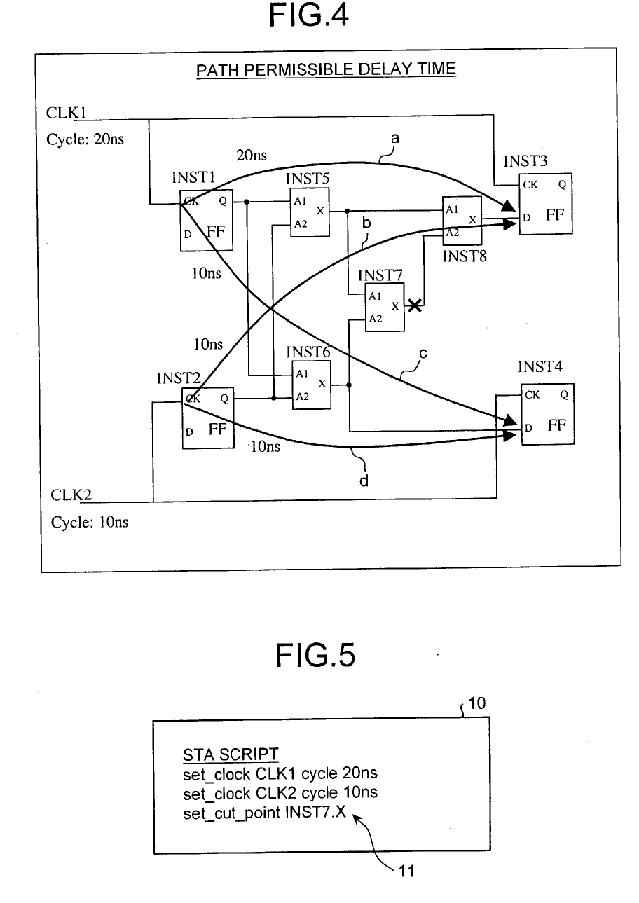

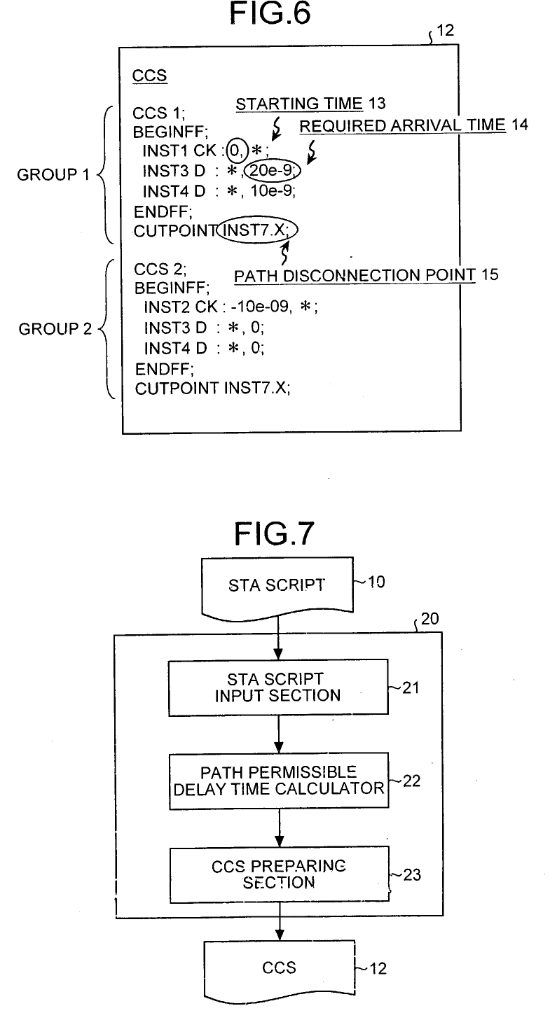

The structure and the processing of preparing the CCSs of one operation mode are explained next. FIG. 4 shows an example of a structure of a logic circuit at the time of preparing CCSs of one operation mode. FIG. 5 shows the contents of the static timing analyzer (STA) script that is necessary to prepare the CCSs. FIG. 6 shows the contents of the CCSs prepared based on the STA scripts.

The logic circuit shown in FIG. 4 is composed of flip-flops (FF) as storage elements and combinational logic elements, which is called cell (instances) INST1 to INST8. Based on the clock cycle of a signal that reaches each of the cell instances INST1 to INST8, a permissible delay time of the propagation of the signal on the path between the cells or between the cell and the I/O terminal is expressed in terms of a signal starting time from the starting cell or the I/O terminal and a signal required arrival time at the ending point cell or the end I/O terminal. The flip-flops are the starting points and the ending points in FIG. 4.

Usually, the timing constraint is described as an STA script 10 as shown in FIG. 5. This constraint is applied to the logic circuit shown in FIG. 4 as the time constraints of the path between the cells, as shown by thick lines a to d in FIG. 4. For example, the permissible delay time is 20 ns on the path a that has a terminal CK of the cell INST1 as the starting point and has a terminal D of the cell INST3 as the ending point.

It is possible to set path disconnection information 11 by assigning set_cut_point in the STA script 10 as shown in FIG. 5. It is possible to exclude all paths that pass through the output (at the position of a mark X) of the cell INST7 in the circuit shown in FIG. 4, from timing verification and optimization.

It is possible to prepare a CCS 12 shown in FIG. 6, based on the path time constraints and the path disconnection information 11 described in the STA script 10 shown in FIG. 5. In the CCS 12, the path that has the terminal CK of the cell INST1 as the starting point and has the terminal D of the cell INST3 as the ending point must satisfy the following time relationship. That is, the signal starts from the terminal CK of the cell INST1 at the time 0 ns, and this signal must reach the terminal D of the cell INST3 by the time 20 ns. This means that the permissible delay time on this path is 20 ns. It is possible to set any values for the starting time and the required arrival time so long as these values correctly express the permissible delay time on the path. For example, when the signal starts from the terminal CK of the cell INST1 at the time 10 ns, and this signal needs to reach the terminal D of the cell INST3 by the time 30 ns, the propagation time satisfies the permissible delay time of 20e-9 (20 ns). Therefore, these times correctly express the permissible delay time.

In the CCS 12 shown in FIG. 4, the time relationship from one BEGINFF to the next BEGINFF forms one information group of one CCS. As one group of information is irrelevant to (i.e., independent of) the other group, it is possible to simply replace the order of a plurality of groups of information, or simply combine the groups. The number of these groups of information is called the number of CCSs. In FIG. 6, the number of the CCSs is two. When the number of the CCSs is smaller, the cost of timing verification and optimization processing becomes smaller. Each group of information has the description of a starting time 13 and a required arrival time 14 at the starting point cell or the I/O terminal and the ending point cell or the I/O terminal respectively, and a path disconnection point 15 shown by CUTPOINT.

FIG. 7 is a block diagram that shows functions of a CCS preparing system for one operation mode. A CCS preparing system 20 includes an STA script input section 21, a path permissible delay time calculator 22, and a CCS preparing section 23. The STA script input section 21 reads a netlist corresponding to the circuit structure shown in FIG. 4, and the timing constraints (the path time constraints, and the path disconnection information) described in the STA script 10 shown in FIG. 5. The path permissible delay time calculator 22 traces the path in the netlist, and check the connection from the starting point to the ending point. Further, the path permissible delay time calculator 22 generates the time constraints of each path obtained by tracing the path, based on the clock information for driving each cell. The CCS preparing section 23 prepares the timing constraints having the time constraints at the starting point cell and the ending point cell of each path.

Preparation of a CCS Considering Operation Modes

A structure and functions of processing for preparing a CCS of operation modes are explained next.

A. Simple Combining of CCSs of Individual Operation Modes

When a plurality of each CCS prepared for one operation mode are simply combined together, no contradiction occurs in the timing constraints. Therefore, it is possible to prepare one CCS that simultaneously expresses operation modes, by combining the CCSs from the operation mode 1 to the operation mode N respectively.

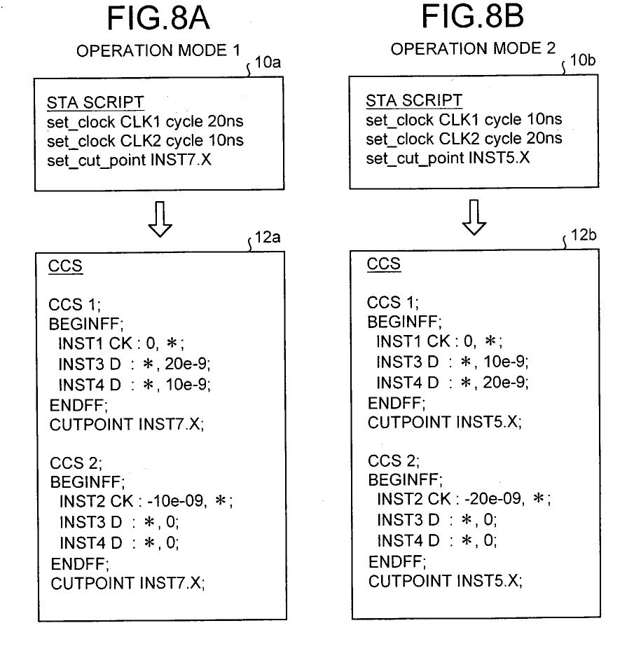

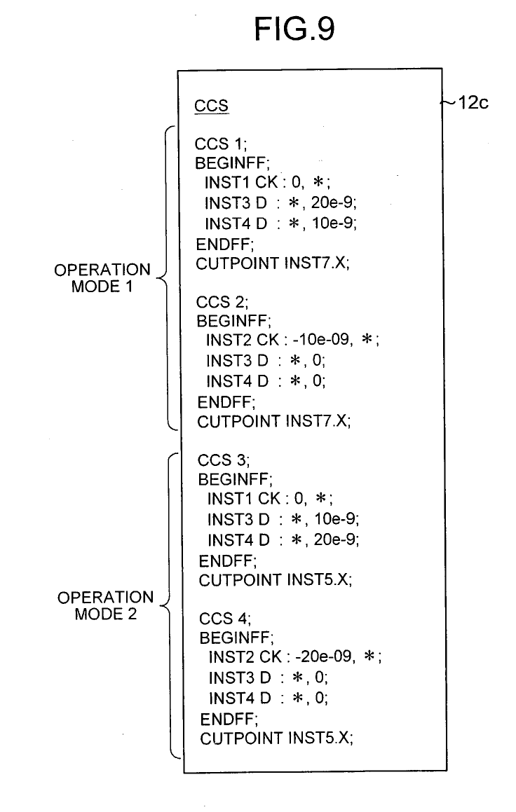

FIGS. 8A and 8B explain the procedure of preparing CCSs of operation modes. FIG. 8A shows the STA script of the operation mode 1 of the circuit structure shown in FIG. 4, and a prepared CCS 12a. FIG. 8B shows the STA script of the operation mode 2, and a prepared CCS 12b. The operation modes 1 and 2 have mutually different path permissible delay times and path disconnection points respectively. The path disconnection point of the operation mode 1 is the output of the cell INST7 shown in FIG. 9, and the path disconnection point of the operation mode 2 is the output of the cell INST5.

FIG. 9 shows a CCS that expresses different operation modes at the same time. It is possible to prepare a CCS 12c that includes the CCS 12a and the CCS 12b at the same time by simply combining these two CCSs obtained for the operation modes 1 and 2, i.e., by describing the CCSs in the order of the operation modes. As the two set path disconnection points for the operation modes 1 and 2 are different from each other, it is possible to simply combine the two CCSs.

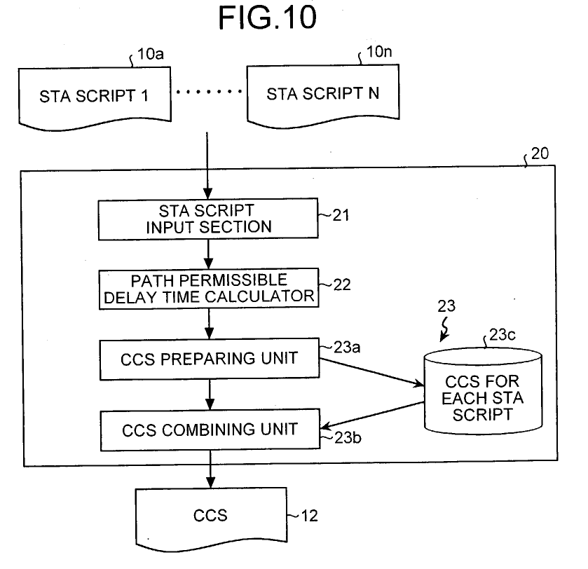

FIG. 10 is a block diagram that shows functions of the CCS preparing system for operation modes. The CCS preparing system 20 includes the STA script input section 21 that inputs the STA scripts 10a to 10n of mutually different operation modes, the path permissible delay time calculator 22, and the CCS preparing section 23, like the CCS preparation system shown in FIG. 7. The CCS preparing section 23 includes a CCS preparing unit 23a that prepares the CCSs 12a to 12n for each one operation mode, and a CCS combining unit 23b that combines the CCSs 12a to 12n prepared for each one operation mode to obtain the CCS 12, and outputs the CCS 12. A storing unit 23c temporarily stores the CCSs 12a to 12n prepared by the CCS preparing unit 23a, for each STA script (i.e., for each operation mode), and outputs these CCSs to the CCS combining unit 23b.

B. Optimization by Deleting Redundant Path Delay Constraints

It is possible to prepare a CCS when the permissible delay time on the path between the cells or between the cell and the I/O unit is known. It is possible to prepare the CCS 12 by converting the timing constraints of each operation mode into the permissible delay time on the path, and by combining all the permissible delay times.

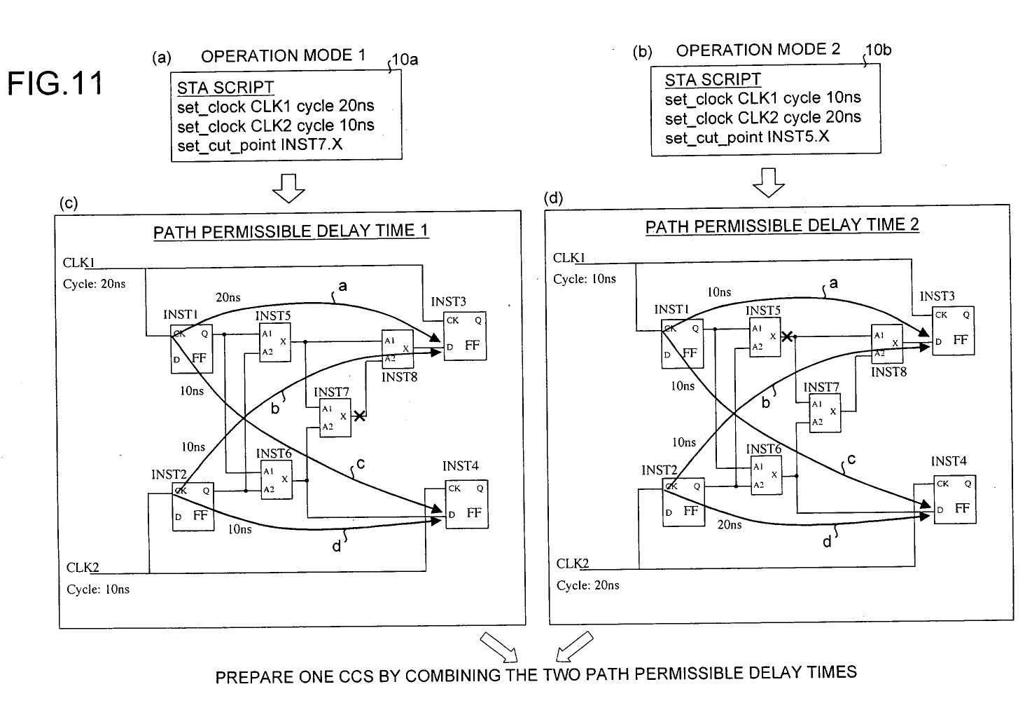

FIG. 11 shows the procedure of preparing the CCS by combining the path permissible delay times. It is possible to reduce the number of CCSs by utilizing the severity of the constraints of the path permissible delay time prepared for each operation mode. For example, the permissible delay times on the path d (i.e., the path from the cell INST2 to the cell INST6 and to the cell INST4) of the circuit structure shown in FIG. 11 are 10 ns for the operation mode 1, and 20 ns for the operation mode 2 respectively. The permissible delay time of 10 ns is severer than that of 20 ns, as the setup condition. Therefore, the permissible delay time on the path d becomes 10 ns. The permissible delay time of 20 ns becomes unnecessary because the constraint of 10 ns includes the constraint of 20 ns.

As explained above, it is possible to optimize the path permissible delay time, by utilizing the severity of the constraints. FIG. 12 shows the CCS prepared based on the optimized information. As general constraints, there are broadly the setup condition and a hold condition. The setup condition handles the constraint of a shortest time as the severest time constraint. On the other hand, the hold condition handles the constraint of a longest time as the severest time constraint.

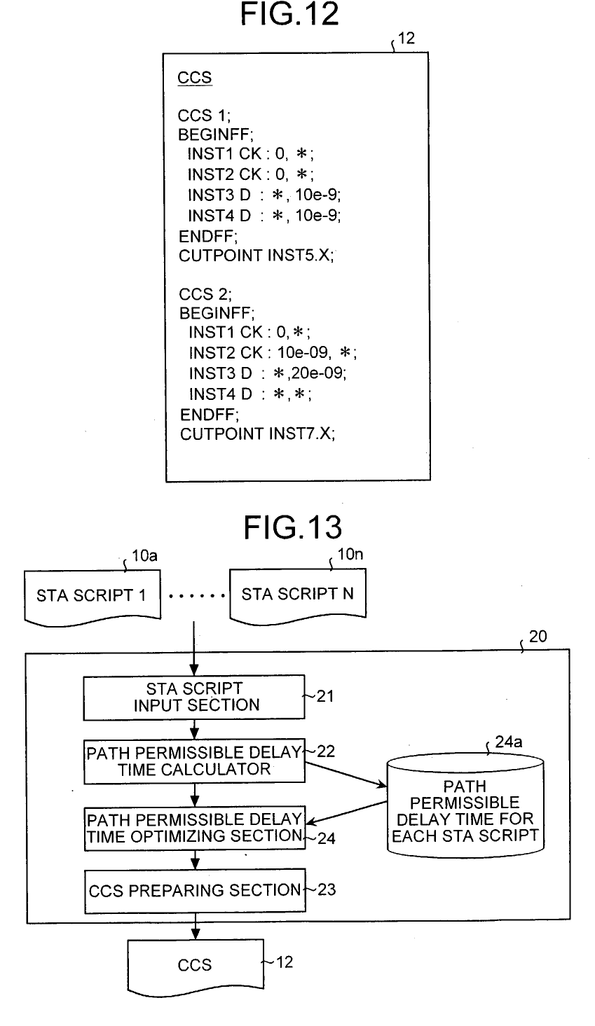

FIG. 13 is a block diagram that shows functions of the CCS preparing system for operation modes. The CCS preparing system 20 includes the STA script input section 21 that inputs the STA scripts 10a to 10n of mutually different operation modes, the path permissible delay time calculator 22, and the CCS preparing section 23, like the CCS preparation system shown in FIG. 7. A path permissible delay time optimizing section 24 optimizes the path permissible delay time calculated by the path permissible delay time calculator 22, and outputs the optimized result to the CCS preparing section 23. A storing unit 24a stores the path permissible delay time calculated by the path permissible delay time calculator 22, for each STA script, and outputs the path permissible delay time to the path permissible delay time optimizing section 24.

As explained above, when the path permissible delay time optimizing section 24 applies the optimized path permissible delay time to the CCS preparing section 23, the CCS preparing section 23 can prepare the optimized CCS 12 having a smaller number of CCSs than that prepared by simply combining the CCSs, without generating redundant timing constraints.

C. Offsetting a Certain Value from all the Path Constraints, or Excluding Path Constraints that Satisfy Assigned Conditions

The CCS preparing section 20 can offset a certain value from all the path permissible delay times or can disregard the path constraint that satisfies the assigned conditions (or can adopt only the path constraint that satisfies the assigned conditions), based on the user's control from the outside.

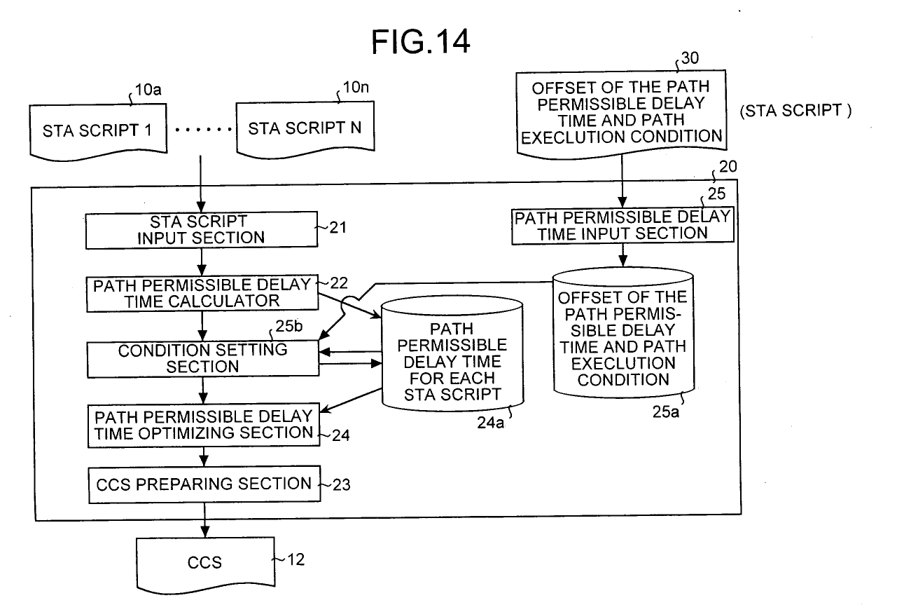

FIG. 14 is a block diagram that shows functions of the CCS preparing system that carries out the path constraint change processing. The CCS preparing system 20 has a path permissible delay time input section 25 that receives path constraint change information 30 from the outside. The path constraint change information is the assignment information that includes the addition, deletion, or offset of the path permissible delay time. This information is described in the STA script. The path permissible delay time input section 25 stores the assigned change information (i.e., a value to be offset from the path permissible delay time, a path exclusion condition, or the like) into the storing unit 25a, and sets this change information to a condition setting section 25b. The condition setting section 25b changes the path permissible delay time stored in the storing unit 24a, based on the set conditions (i.e., the offsetting, the exclusion of the paths that match the path exclusion conditions, or the like), and outputs the changed result to the path permissible delay time optimizing section 24. The CCS preparing section 23 prepares the CCS 12.

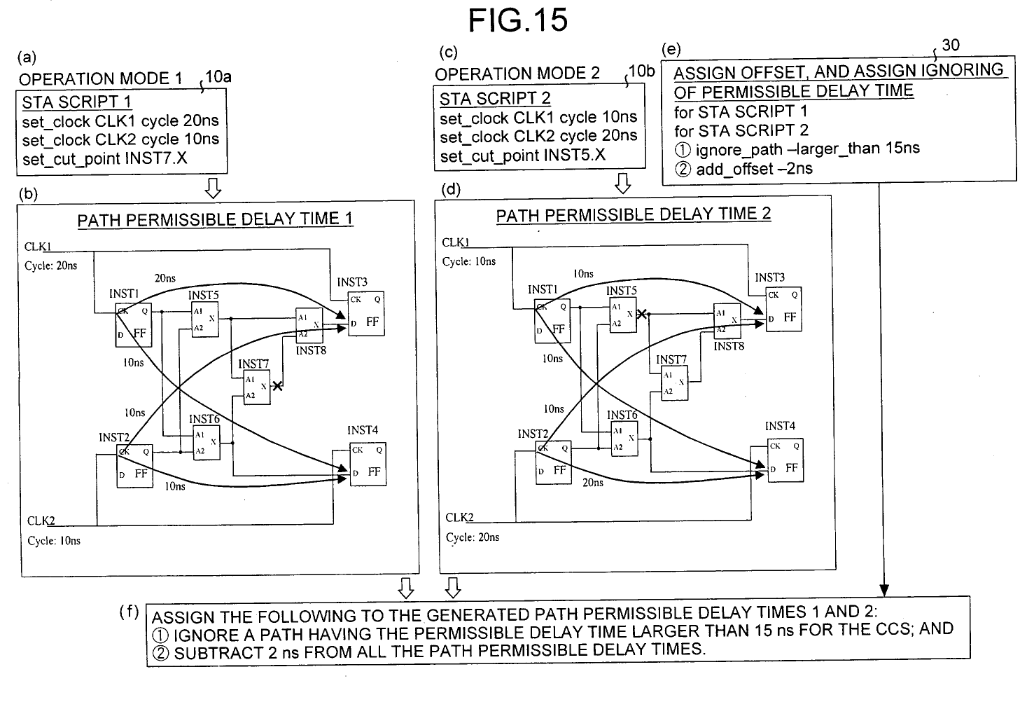

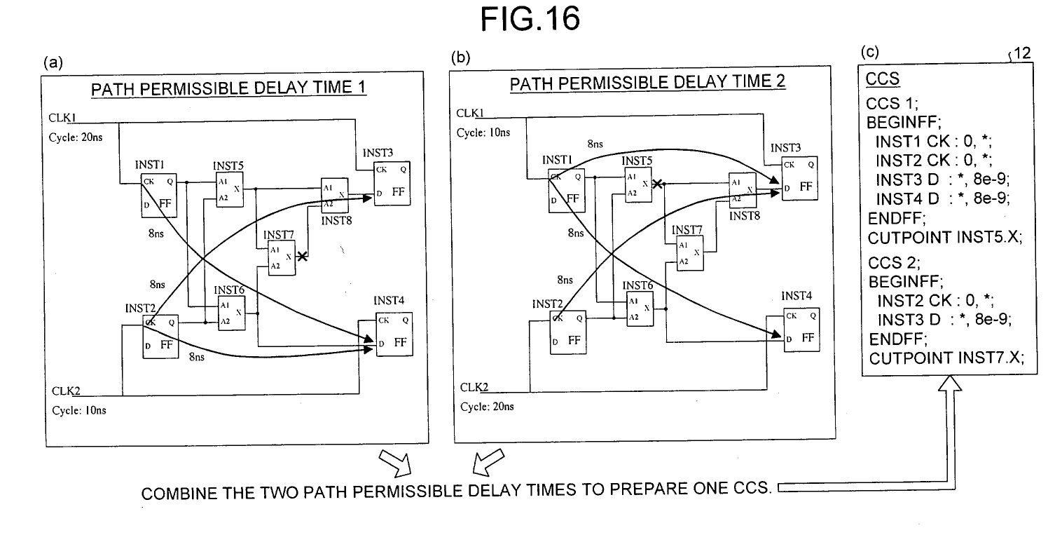

FIGS. 15 and 16 show procedures of preparing a CCS changed path constraints. FIG. 15 shows the description contents of the STA script 10a of the operation mode 1 (see (a)), the timing constraints of the STA script 10a (see (b)), the description contents of the STA script 10b of the operation mode 2 (see (c)), and the timing constraints of the STA script 10b (see c).

Assume that, as the path constraint change information 30 is as shown in (e), the assignments are made to the generated path permissible delay times 1 and 2 as shown in (f):

(1) ignore a path having the permissible delay time larger than 15 ns for the CCS (ignore_path_larger_than 15 ns); and

(2) subtract 2 ns from all the path permissible delay times (add_offset-2 ns).

Based on the assignments, the condition setting section 25b changes all the path permissible delay time from 10 ns to 8 ns. FIG. 16 shows examples that the path constraint permissible values of the operation modes 1 and 2 after changing the path constraints are expressed on the circuit structures respectively (see (a) and (b)), and the states that the assignments (1) and (2) are satisfied. FIG. 16 also shows the CCS 12 prepared by combining the two path permissible delay times (see (c)).

It is possible to use the assignment of offsetting a certain value from the path permissible delay times or the exclusion of path constraints that satisfy the assigned conditions, as instructions for optimizing a certain specific permissible value with priority, or excluding this specific permissible value from the optimization, or optimizing the total permissible values under severer or milder conditions than the STA script, in optimizing the timing of the circuit in the TDL.

D. Restructuring or Re-Optimization the Existing CCS

It is possible to restore the path permissible delay time based on the description of the CCS. The CCS preparing system 20 can restructure or re-optimize the existing CCS. The CCS preparing system 20 can store the existing CCS, and simply combine this CCS with other CCS prepared based on the other STA script (as explained in the above “A. Simple combining of CCSs of individual operation modes”). The CCS preparing system 20 can also restore the path permissible delay time from the stored CCS, and re-optimize the path permissible delay time.

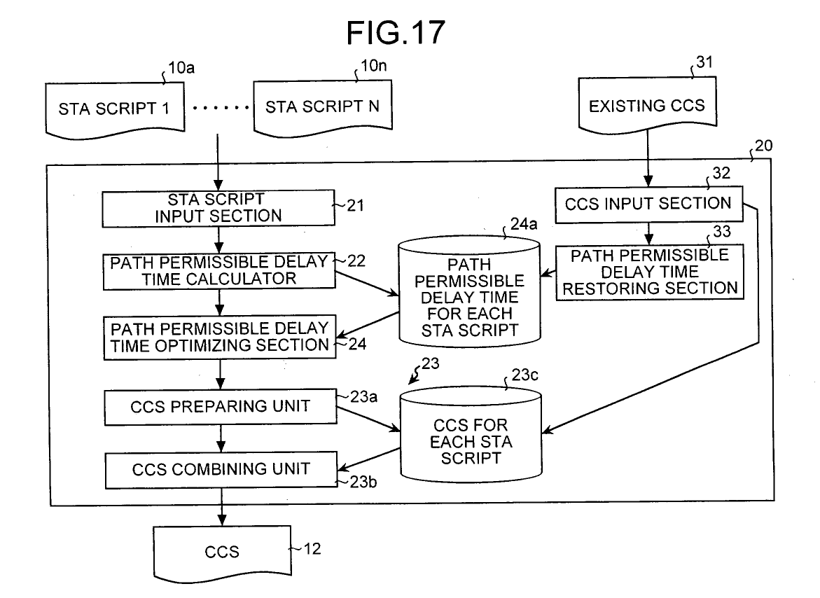

FIG. 17 is a block diagram that shows functions of the CCS preparing system that restructures and re-optimizes the existing CCS. The CCS preparing system 20 includes the STA script input section 21 that inputs the STA scripts 10a to 10n of mutually different operation modes, the path permissible delay time calculator 22, the CCS preparing section 23, the path permissible delay time optimizing section 24, and the storing unit 24a. The CCS preparing section 23 includes the CCS preparing unit 23a, the CCS combining unit 23b, and the storing unit 23c.

The CCS preparing section 23 also includes a CCS input section 32 that can input an existing CCS (i.e., STA script) 31, and a path permissible delay time restoring section 33 that restores a CCS path permissible delay time based on the description of the input existing CCS 31. The CCS input section 32 stores the input existing CCS 31 into the storing unit 23c. The path permissible delay time restoring section 33 stores the restored path permissible delay time into the storing unit 24a.

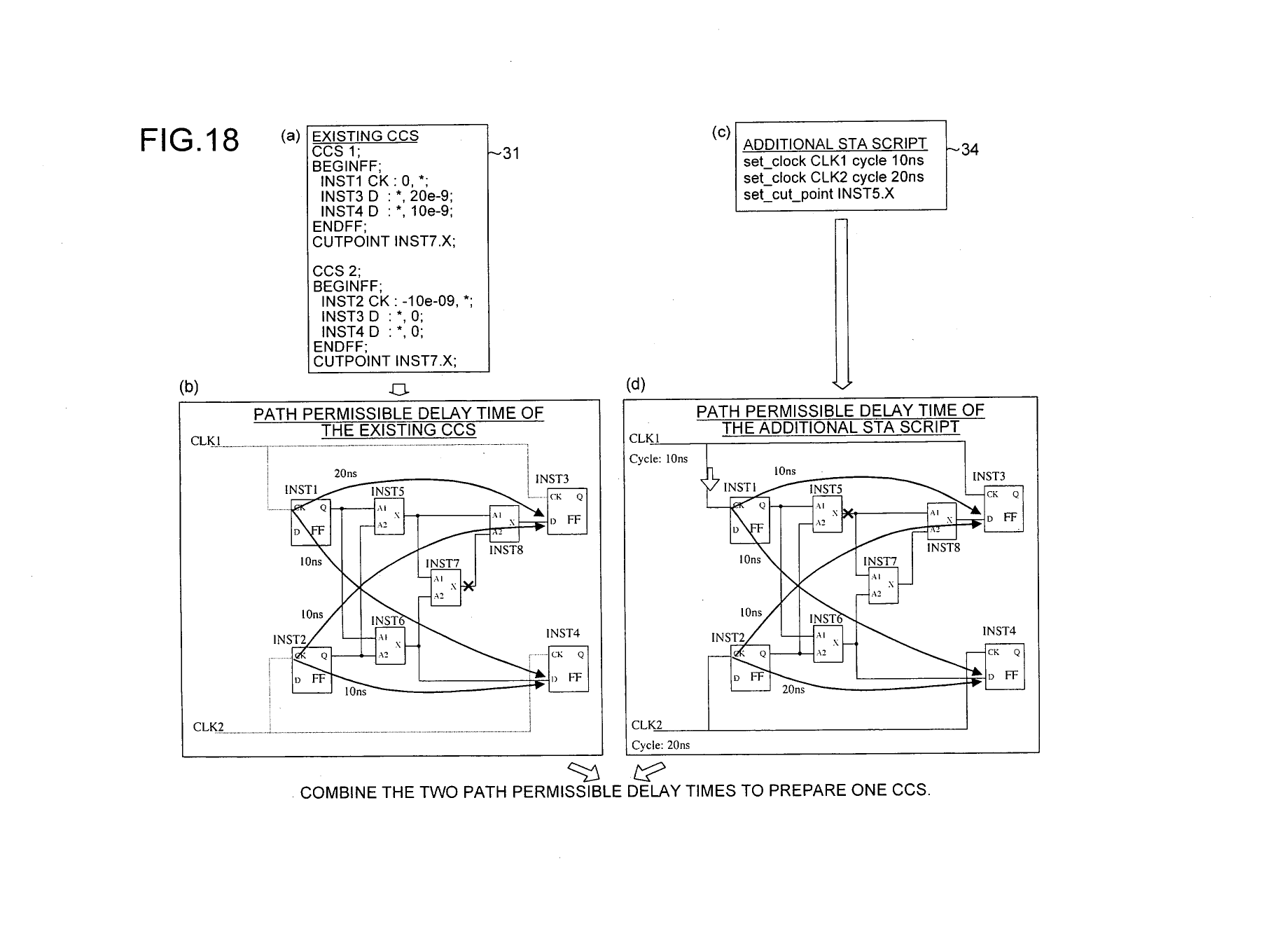

FIG. 18 shows the procedure of preparing the CCS based on the existing CCS and the additional STA script. This figure shows the existing CCS (see (a)), the contents of the timing constraints restored based on the description of the existing CCS (see (b)), an additional STA script 34 added by the user (see (c)), and the contents of the timing constraints described in the additional STA script (see (d)). The existing CCS 31 coincides with the contents shown in FIG. 5, for the sake of convenience. Similarly, the path permissible delay times of the existing CCS coincide with the data shown in FIG. 4.

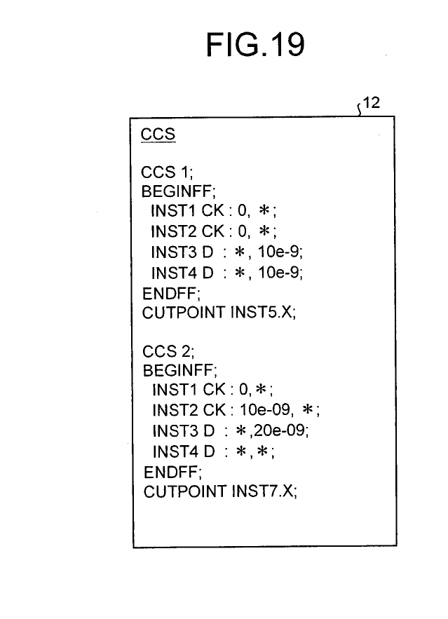

The CCS preparing system 20 restores the timing constraints shown in (b) based on the existing CCS 31 shown in (a). The CCS preparing system 20 obtains the timing constraints shown in (d) based on the additional STA script 34 shown in (c). FIG. 19 shows the CCS obtained by simply combining the additional STA script. The CCS preparing system 20 prepares the CCS 12 shown in FIG. 19 by simply combining the two path permissible delay times shown in (b) and (c) respectively of FIG. 18. This CCS 12 satisfies the existing CCS 31 and the additional STA script at the same time.

The application of the CCS based on the structure is explained next.

(a) At the time of optimizing the layout of timing constraints by adding other operation mode after the TDL optimizes the timing constraints of a certain CCS, it is possible to effectively utilize the existing CCS. Based on the simple combining of the CCSs, it is possible to re-utilize the entire existing CCS, and it is possible to easily obtain the optimized CCS without re-calculating the path permissible delay time.

(b) At the initial stage of designing an LSI, the timing constraints of all the operation modes are not necessarily available. The timing constraints for the most important operation modes become available first. By effectively utilizing the existing CCS, it is possible to sequentially prepare the timing constraints of other operation modes.

E. Generating Timing Constraints for the Conventional System that Cannot Handle Operation Modes at the Same Time

As explained above, the conventional TDL can handle only one timing constraint (i.e., operation mode) at one time. However, according to the present invention, it is possible to generate timing constraints that can optimize the operation timing of operation modes, even when the logic combining system includes this kind of TDL. According to the conventional STA script describing system, it is possible to assign exceptional information to a certain timing constraint among various timing constraints on different paths. For example, when the permissible delay time is 10 ns on the path from the INST1 to the INST5 and to the INST6, the conventional system describes the assignment as follows.

set_pin_to_pin_timing-source INST1.CK-point INST5.X-sink INST6.D 10 ns

According to the conventional method (2) for optimizing the timing of operation modes by using the conventional system, the system executes many times this kind of exceptional assignment of timing constraint on the path.

On the other hand, the CCS preparing system 20 according to the present invention can compare the path permissible delay times that the plurality of STA scripts describe, as explained in “B. Optimization by deleting redundant path delay constraints”. Therefore, by using the STA script of a certain operation as a reference script, it is possible to extract a path permissible delay time of other STA script that is severer than the constraint expressed in the reference script. It is possible to output this severer constraint as the exceptional information on the paths.

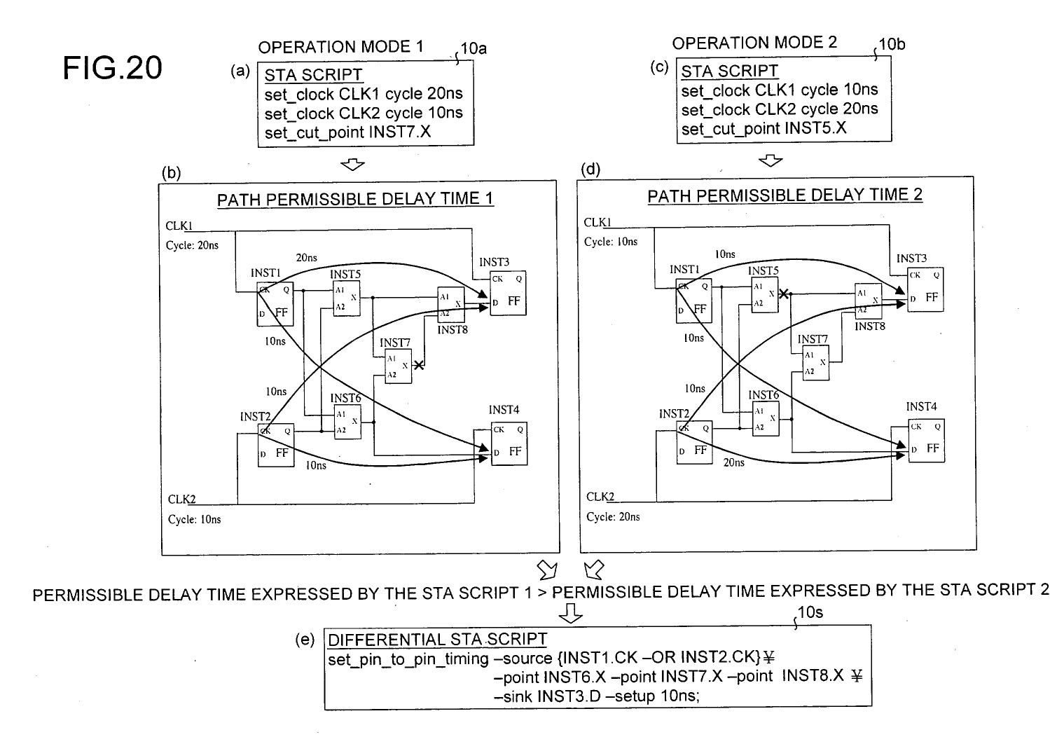

FIG. 20 shows a procedure in which the CCS preparing system prepares a differential script based on STA scripts of different operation modes. This figure shows the STA script 10a of the operation mode 1 (see (a)), the contents of the timing constraints corresponding to the STA script 10a (see (b)), the STA script 10b of the operation mode 2 (see (c)), and the contents of the timing constraints corresponding to the STA script 10b (see (d)).

As shown in (e) of FIG. 20, the CCS preparing system 20 extracts a differential STA script 10s, based on the timing constraints described in the STA script 10a of the operation mode 1 and the STA script 10b of the operation mode 2 respectively. This differential STA script 10s is the exceptional information of the timing constraints on the paths.

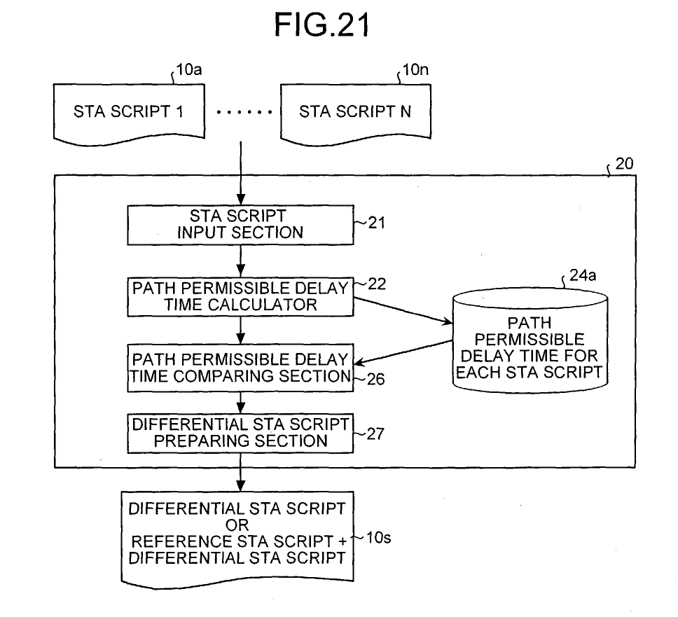

FIG. 21 is a block diagram that shows functions of the CCS preparing system that generates the differential STA script. The CCS preparing system 20 includes the STA script input section 21 that inputs the STA scripts 10a to 10n of mutually different operation modes, the path permissible delay time calculator 22, and the storing unit 24a. The storing unit 24a stores the path permissible delay time calculated by the path permissible delay time calculator 22. A path permissible delay time comparing section 26 compares the path permissible delay times, and outputs the result of the comparison to a differential STA script preparing section 27. The differential STA script preparing section 27 prepares the differential STA script (or the reference STA script+the differential STA script) 10s based on the result of the comparison.

The differential STA script preparing section 27 outputs the result of the comparison in two ways as follows.

(1) When the user assigns a certain STA as a reference STA script, the differential STA script preparing section 27 outputs only the differential STA script that is different from the reference STA script.

(2) When the user does not assign a certain STA as a reference STA script, the differential STA script preparing section 27 outputs “the reference STA script+the differential STA script” to minimize the quantity of the differential STA script. In general, it is difficult for the user to select the reference STA script to minimize the quantity of the differential STA script.

The extraction of the differential STA script is not limited to that based on the comparison between the STA scripts. It is also possible to obtain timing constraints that take into account the operation mode 1 and the operation mode 2, by combining the STA script of the operation mode 1 with the differential STA script of the operation mode 2 output from the CCS preparing system 20.

Entire Structure of the CCS Preparing System that Takes into Account Operation Modes

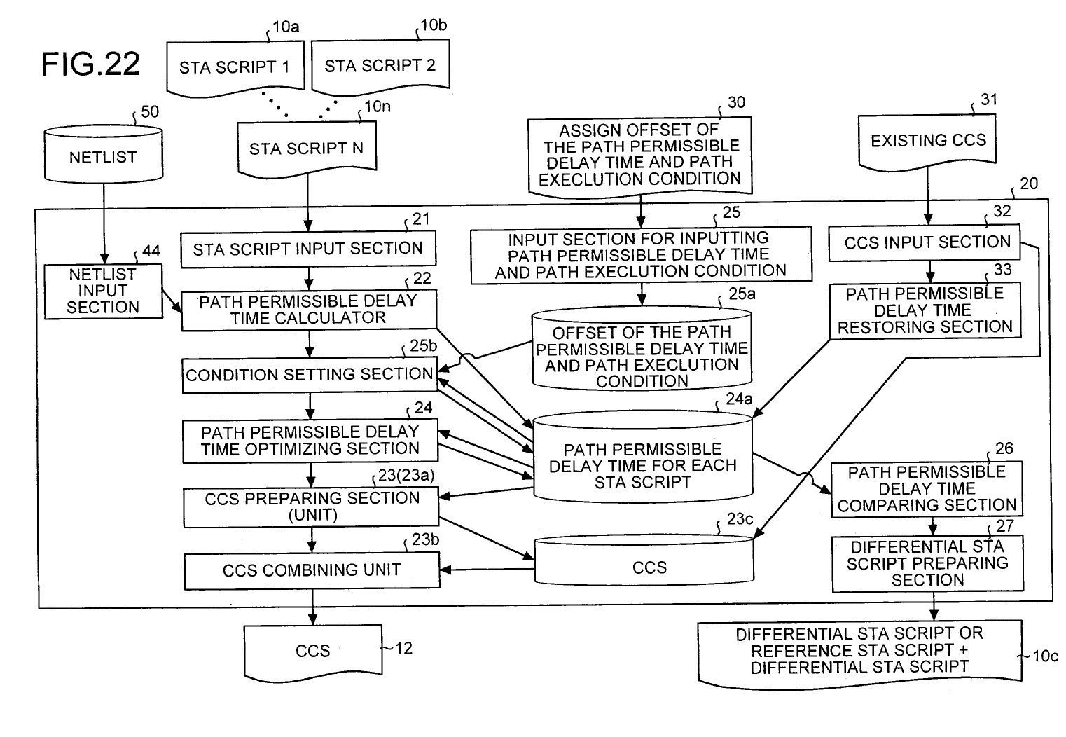

FIG. 22 is a block diagram that shows a total structure of the CCS preparing system. The CCS preparing system 20 comprises all the units that realize the functions A to E. It is possible to use a computer having a CPU to execute a predetermined processing program to achieve these functions of the CCS preparing system 20.

Timing-Driven Layout System that Simultaneously Takes into Account Operation Modes

The CCS (i.e., the timing constraint model CCS) prepared by the CCS preparing system 20 corresponds to the processing at step S1 shown in FIG. 3. The TDL optimizes all the timing constraints of the prepared CCSs by simultaneously taking into account these timing constraints, as shown at step S2 in FIG. 3.

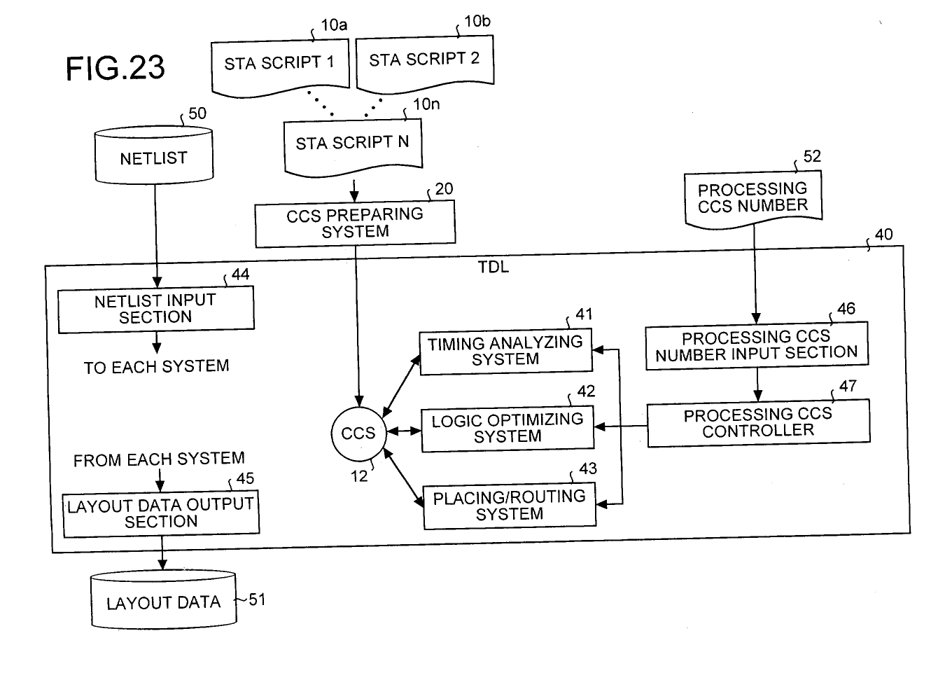

FIG. 23 is a block diagram that shows the timing-driven layout system using the CCS. A TDL 40 has the input of the CCS (timing constraint model CCS) 12 prepared by the CCS preparing system 20. A timing analyzing system 41, a logic optimizing system 42, and a placing/routing system 43 use this CCS 12 respectively.

The timing analyzing system 41 analyzes the timing of logic circuit under the timing constraints in the CCS 12. The logic optimizing system 42 optimizes the delay (structure) in the logic circuit based on the CCS 12. The placing/routing system 43 optimizes the placement of the cells (i.e., the circuit elements) and the routing pattern based on the CCS 12. A netlist input section 44 receives the input of a netlist 50 of the circuit structure. The systems 41 to 43 refer to this netlist 50. The TDL 40 outputs to the outside, a layout data 51 of the circuit structure obtained based on the processing by the systems 41 to 43.

The TDL 40 can process all or a selected part of the input CCS 12. For this purpose, the TDL 40 has a processing CCS number input section 46, and a processing CCS controller 47. The processing CCS number input section 46 receives the input of a processing CCS number 52 assigned by the user or the like. The processing CCS controller 47 assigns the assigned processing CCS number 52 to the systems 41 to 43 respectively.

As explained above,

(1) the TDL 40 can simultaneously take into account all the assigned CCS (groups of information), and

(2) the TDL 40 can take into account only the assigned part of the CCS (groups of information).

The above (1) means that it is possible to prepare the layout by simultaneously taking into account all the operation modes. Usually, the TDL 40 operates based on this function. The above (2) means that it is possible to prepare the layout by taking into account only a part of the operation modes. The application of (2) is as follows. First, the TDL 40 optimizes the most important operation mode, and confirms whether the layout result that satisfies the given timing constraints is actually obtained. When the layout that satisfies the timing constraints is not obtained, it is not possible to obtain the layout that has the most important operation mode, even when other operation modes are considered at the same time. For example, the general-purpose system mode is considered more important than the test mode.

When the timing constraints of a part of the operation modes are not complete, the TDL 40 optimizes the layout by disregarding the corresponding CCS 12. After ending the layout optimization, the TDL 40 only analyzes whether the timing constraints of the CCS 12 not considered are satisfied.

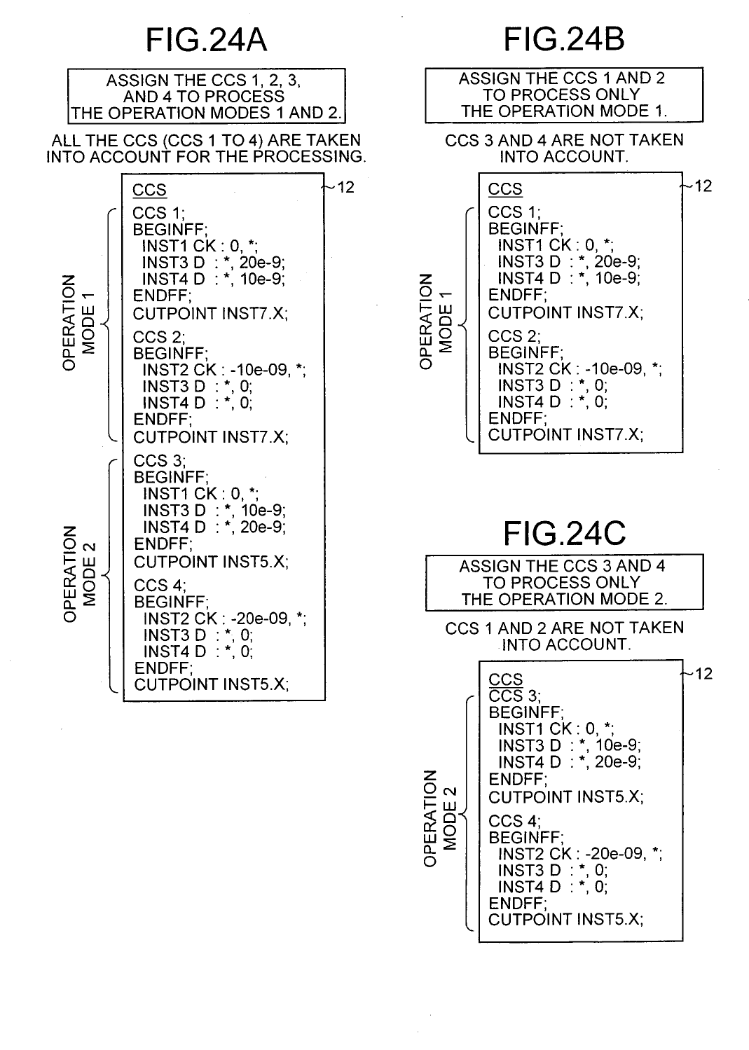

FIGS. 24A to 24C explain the assignment of CCSs to be processed by the TDL. FIG. 24A shows that the TDL 40 processes all CCSs of the operation modes 1 and 2 described in the CCS 12 prepared. In this case, the user assigns the CCSs 1, 2, 3, and 4 respectively as the CCS numbers of the CCSs to be processed. FIG. 24B shows that the TDL 40 processes only the CCSs of the operation mode 1 described in the CCS 12 prepared. In this case, the user assigns the CCSs, 1 and 2 as the CCS numbers of the CCSs to be, processed. The TDL 40 does not process the CCSs 3 and 4 of the operation mode 2. FIG. 24C shows that the TDL 40 processes only the CCSs of the operation mode 2 described in the CCS 12 prepared. In this case, the user assigns the CCSs 3 and 4 as the CCS numbers of the CCSs to be processed. The TDL 40 does not process the CCSs 1 and 2 of the operation mode 1.

Each of the timing analyzing system 41, the logic optimizing system 42, and the placing/routing system 43 of the TDL 40 respectively can operate independently based on the input CCS 12. The CCS 12 itself is the timing constraint model that does not depend on the sequence of designing the circuit. As each group of information in the CCS 12 is independent of each other, it is possible to carry out the delay calculation, the verification, and the slack analysis of each group of information, independent of each other, or in parallel.

In the general logic combining, placing, and routing system, the system processes according to the slack (i.e., freedom in a timing constraint delay in the circuit) calculated at each point of the circuit as cost (i.e., a part of the evaluation function). A plurality of slacks exist in the CCS 12 at a certain point in the designed circuit structure. Usually, only the worst slack may be considered. The worst slack at each point is the worst value (i.e., the minimum value) among the slacks obtained in each group of information in the CCS 12. The logic optimizing system 42 analyzes the slacks in the CCS 12, and optimizes the delay of the circuit placing/routing, based on the slacks as constraints. The layout/wiring system 43 changes the placement and the route based on these values as cost.

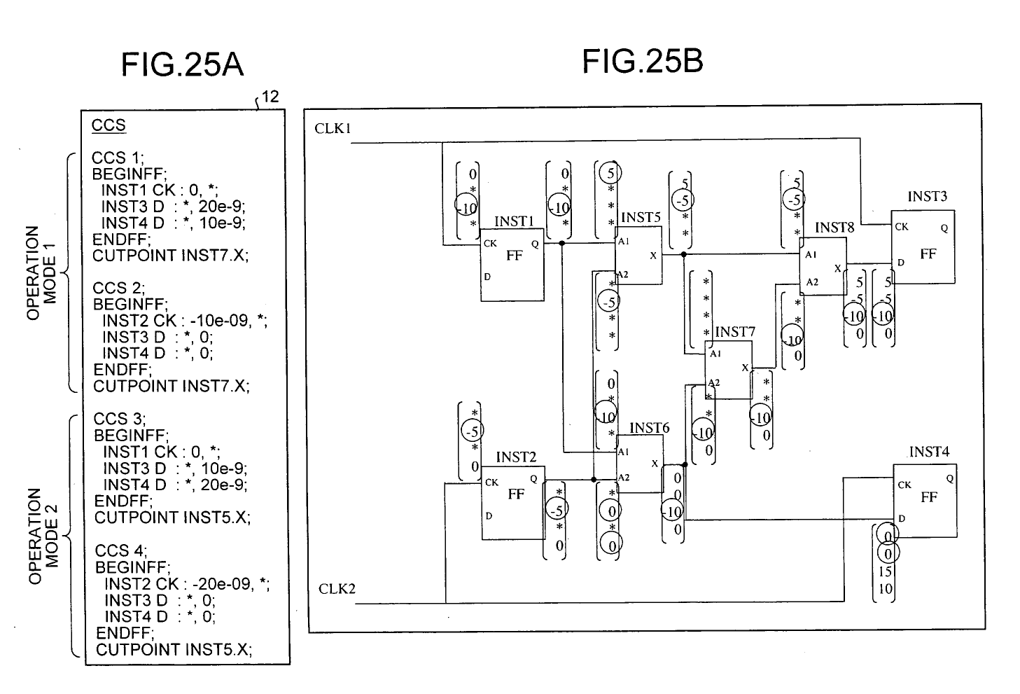

FIGS. 25A and 25B show one example of a CCS and a result of a slack analysis. FIG. 25A shows the CCS 12. FIG. 25B shows a result of the analysis carried out based on the CCS 12. It is assumed that the delay in each of the cell INST1 to INST8 is 5 ns (5.0e-09) as a constant. To simplify the expression, e-09 is omitted from each slack value. Slacks are shown in each cell portion [ ]. The slacks are expressed within each [ ] for each of the CCS 1 to the CCS4 respectively described in this order from the top in the CCS 12. The minimum slack in each [ ] is encircled with a round mark. When the TDL 40 selects only the operation mode 1 (that includes the CCSs 1 and 2), for example, the logic optimizing system 42 analyzes only the slacks in the CCSs 1 and 2.

It is possible to structure the TDL 40 using a computer having a CPU. The computer executes a processing program corresponding to the timing inspecting system 41, the logic optimizing system 42, and the placing/routing system 43, thereby to realize the respective functions. It is needless to mention that the same computer may be made to realize both the CCS preparing system 20 and the TDL 40.

A computer such as a personal computer or a workstation can realize the CCS preparation processing and the TDL processing by executing the program prepared in advance. This program is recorded on various kinds of recording mediums, and the computer executes the program by reading the program from the recording mediums. The program may be distributed via a transmission medium of a network such as the Internet.

According to the present invention, it is possible to prepare the timing constraint models (i.e. the CCSs) of different operation modes by using the STA scripts. There is an effect that it is possible to simply combine the descriptions of CCSs to obtain one CCS. There is also an effect that it is possible to generate a CCS by selecting a permissible delay time suitable for a predetermined constraint such as a setup condition. The timing-driven layout system using this timing constraint model can generate a circuit that simultaneously optimizes the timing of the circuit under the timing constraints of operation modes. Therefore, there is an effect that it is possible to decrease the number of processing to optimize the timing of the circuit, shorten the processing turnaround time, optimize the logic by avoiding the incessant temporary sub-optimization, and shorten the design turnaround time.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of generating a timing constraint model of a logic circuit that has one of a cell and an I/O terminal as a starting point and one of the cell and the I/O terminal as an ending point for each of a plurality of paths, the method comprising:
extracting, based on a clock information that is supplied to the logical circuit and a disconnection information that indicates which path is to be disconnected from among the plurality of paths, paths that do not have the disconnection information, and calculating a permissible delay time from the starting point to the ending point of each path based on the clock information of the paths extracted; and
preparing, based on the calculated permissible delay time, which is equivalent to a time constraint of the extracted paths, and the disconnection information, a timing constraint model, for a plurality of groups in such a manner as to have no contradiction between the paths extracted and the disconnection information.

2. The method according to claim 1, wherein the timing constraint model is equivalent to a compatible constraint set.

3. A method of generating a timing constraint model of a logic circuit that has one of a cell and an I/O terminal as a starting point and one of the cell and the I/O terminal as an ending point for each of a plurality of paths, the method comprising:
reading a static timing analyzer script that describes a clock information and a disconnection information, the clock information being supplied to the logical circuit, and the disconnection information indicating which path is to be disconnected from among the plurality of paths;
extracting, based on the static timing analyzer script, paths that do not have the disconnection information;
calculating a permissible delay time from the starting point to the ending point of each path extracted based on the clock information; and
preparing, based on the calculated permissible delay time, which is equivalent to a time constraint of the extracted paths, and the disconnection information, a timing constraint model, which is equivalent to a compatible constraint set, for a plurality of groups in such a manner as to have no contradiction between the paths extracted and the disconnection information.

4. The method according to claim 3, wherein at the step of receiving input of a plurality of the static timing analyzer scripts are received corresponding to each of different operation modes of a single logic circuit, and the method further comprising:
combining the descriptions of the plurality of the compatible constraint sets for each operation mode prepared at the step of preparing, thereby to obtain one compatible constraint set.

5. The method according to claim 4, further comprising:
selecting a permissible delay time suitable for a predetermined constraint set in advance, from among a plurality of permissible delay times obtained for each operation mode on the same path, by referring to the permissible delay times on each path calculated at the step of calculating, and outputting the selected permissible delay time to the step of preparing.

6. The method according to claim 5, wherein
the constraints include a setup condition having a short permissible delay time, and a hold condition having a long permissible delay time.

7. The method according to claim 3, further comprising receiving an external input of a change in the path permissible delay time, wherein
at the step of calculating, a path permissible delay time is added, deleted, or corrected, or a certain value is offset from all the path permissible delay times.

8. The method according to claim 3, further comprising:
receiving an input of an existing compatible constraint set already prepared; and
decoding the description of the compatible constraint set input, and restoring the permissible delay time on a cell starting point to a cell ending point of each path, wherein
at the step of preparing step, a compatible constraint set is prepared based on the outputs obtained at the step of calculating and the step of decoding respectively.

9. The method according to claim 3, further comprising:
comparing the path permissible delay times based on at least a pair of the static timing analyzer scripts input at the step of receiving, and extracting a differential between the permissible delay times.

10. A computer program which generates a timing constraint model of a logic circuit that has one of a cell and an I/O terminal as a starting point and one of the cell and the I/O terminal as an ending point for each of a plurality of paths on a computer, the computer program making the computer execute:
reading a static timing analyzer script that describes a clock information and a disconnection information, the clock information being supplied to the logical circuit, and the disconnection information indicating which path is to be disconnected from among the plurality of paths;
extracting, based on the static timing analyzer script, paths that do not have the disconnection information;
calculating a permissible delay time from the starting point to the ending point of each path extracted based on the clock information; and
preparing, based on the calculated permissible delay time, which is equivalent to a time constraint of the extracted paths, and the disconnection information, a timing constraint model, which is equivalent to a compatible constraint set, for a plurality of groups in such a manner as to have no contradiction between the paths extracted and the disconnection information.

11. A timing-driven layout method comprising:
generating a timing constraint model of a logic circuit that has one of a cell and an I/O terminal as a starting point and one of the cell and the I/O terminal as an ending point for each of a plurality of paths, the step of generating including
reading a static timing analyzer script that describes a clock information and a disconnection information, the clock information being supplied to the logical circuit, and the disconnection information indicating which path is to be disconnected from among the plurality of paths;
extracting, based on the static timing analyzer script, paths that do not have the disconnection information;
calculating a permissible delay time from the starting point to the ending point of each path extracted based on the clock information; and
preparing, based on the calculated permissible delay time, which is equivalent to a time constraint of the extracted paths, and the disconnection information, a timing constraint model, which is equivalent to a compatible constraint set, for a plurality of groups in such a manner as to have no contradiction between the paths extracted and the disconnection information;
analyzing the delay characteristic of the logic circuit under the timing constraints described in the compatible constraint set based on the compatible constraint set prepared;
optimizing a delay in the logic circuit based on the timing constraints described in the compatible constraint set; and
optimizing placement and route of a layout of the logic circuit based on the timing constraints described in the compatible constraint set.

12. The method according to claim 11, wherein
when optimizing the delay, all the time constraints or a part of the time constraints described in the prepared compatible constraint set is optimized.

13. The method according to claim 12, wherein the step of optimizing the delay includes
assigning the description in the compatible constraint set to be optimized.

14. A computer program that makes a computer execute:
generating a timing constraint model of a logic circuit that has one of a cell and an I/O terminal as a starting point and one of the cell and the I/O terminal as an ending point for each of a plurality of paths, the step of generating including
reading a static timing analyzer script that describes a clock information and a disconnection information, the clock information being supplied to the logical circuit, and the disconnection information indicating which path is to be disconnected from among the plurality of paths;
extracting, based on the static timing analyzer script, paths that do not have the disconnection information;
calculating a permissible delay time from the starting point to the ending point of each path extracted based on the clock information; and
preparing, based on the calculated permissible delay time, which is equivalent to a time constraint of the extracted paths, and the disconnection information, a timing constraint model, which is equivalent to a compatible constraint set, for a plurality of groups in such a manner as to have no contradiction between the paths extracted and the disconnection information;
analyzing the delay characteristic of the logic under the timing constraints described in the compatible constraint set;
optimizing the delay in the logic circuit based on the timing constraints described in the compatible constraint set; and
optimizing placement and route of a layout of the logic circuit based on the timing constraints described in the compatible constraint set.

15. An apparatus that generates a timing constraint model of a logic circuit that has one of a cell and an I/O terminal as a starting point and one of the cell and the I/O terminal as an ending point for each of a plurality of paths, the apparatus comprising:
an STA input unit that reads a static timing analyzer script that describes a clock information and a disconnection information, the clock information being supplied to the logical circuit, and the disconnection information indicating which path is to be disconnected from among the plurality of paths;
a calculating unit that extracts, based on the static timing analyzer script, paths that do not have the disconnection information, and calculates a permissible delay time from the starting point to the ending point of each path extracted based on the clock information; and
a preparing unit that prepares based on the calculated permissible delay time, which is equivalent to a time constraint of the extracted paths, and the disconnection information, a timing constraint model, which is equivalent to a compatible constraint set, for a plurality of groups in such a manner as to have no contradiction between the paths extracted and the disconnection information.

16. The apparatus according to claim 15, wherein the STA input unit receives inputs of the static timing analyzer scripts corresponding to each of different operation modes of the single logic circuit, and the apparatus further comprising:
a combining unit that simply combines the descriptions of the compatible constraint sets for each operation mode prepared by the preparing unit, thereby to obtain one compatible constraint set.

17. The apparatus according to claim 16, further comprising:
a selecting unit that selects a permissible delay time suitable for a predetermined constraint set in advance, from among permissible delay times obtained for each operation mode on the same path, by referring to the permissible delay times on each path calculated by the calculating unit, wherein
the constraints set by the calculating unit include a setup condition having a short permissible delay time, and a hold condition having a long permissible delay time.

18. The apparatus according to claim 15, further comprising:
a time input unit that receives an external input of a change in the path permissible delay time, wherein
the calculating unit adds, deletes, or corrects a path permissible delay time, or offsets a certain value from all the path permissible delay times.

19. The apparatus according to claim 15, further comprising:
a CCS input unit that receives an input of an existing compatible constraint set already prepared; and
a restoring unit that decodes the description of the prepared compatible constraint set input to the CCS input unit, and restores the permissible delay time on a cell starting point to a cell ending point of each path, wherein
the preparing unit prepares a compatible constraint set based on the outputs from the calculating unit and the restoring unit respectively.

20. The apparatus according to claim 15, further comprising:
a differential STA script preparing unit that compares the path permissible delay times based on at least a pair of the static timing analyzer scripts input to the static timing analyzer script input unit, and extracts a differential between the permissible delay times.

21. A timing-driven layout system, comprising:
a generating unit that generates a timing constraint model of a logic circuit that has one of a cell and an I/O terminal as a starting point and one of the cell and the I/O terminal as an ending point for each of a plurality of paths, the generating unit including
an STA input unit that reads a static timing analyzer script that describes a clock information and a disconnection information, the clock information being supplied to the logical circuit, and the disconnection information indicating which path is to be disconnected from among the plurality of paths;
a calculating unit that extracts, based on the static timing analyzer script, paths that do not have the disconnection information, and calculates a permissible delay time from the starting point to the ending point of each path extracted based on the clock information; and
a preparing unit that prepares based on the calculated permissible delay time, which is equivalent to a time constraint of the extracted paths, and the disconnection information, a timing constraint model, which is equivalent to a compatible constraint set, for a plurality of groups in such a manner as to have no contradiction between the paths extracted and the disconnection information;
an analyzing unit that analyzes the delay characteristic of the logic circuit under the timing constraints described in the compatible constraint set;
a logic optimizing unit that optimizes the delay in the logic circuit based on one of all and a part of the timing constraints described in the prepared compatible constraint set;
a compatible constraint set input unit that assigns the description in the compatible constraint set to be optimized; and
a placing/routing optimizing unit that optimizes placement and route of a layout of the logic circuit based on the timing constraints described in the compatible constraint set.
